(19) United States
(12) Patent Application Publication
(10) Pub. No.: US 2021/0129440 A1
(43) Pub. Date: May 6, 2021

(54) Apparatus for Additively Manufacturing Three-Dimensional Objects

(71) Applicant: Concept Laser GmbH, Lichtenfels (DE)

(72) Inventors: Philipp Schumann, Lichtenfels (DE); Jack Robert Crawley, London (GB)

(21) Appl. No.: 16/670,409

(22) Filed: Oct. 31, 2019

(51) Int. Cl. B29C 64/379; B29C 64/209; B29C 64/264; B29C 64/245; B29C 64/386

(52) U.S. Cl. CPC B29C 64/379; B29C 64/209; B33Y 30/00; B29C 64/245; B29C 64/386; B29C 64/264

(57) ABSTRACT

Apparatuses for additively manufacturing three-dimensional objects may include at least one robot device that is adapted to move at least one interacting unit of the robot device in a movement region that is larger than a process plane which contains the build plane. Robot devices for an apparatus for additively manufacturing three-dimensional objects may include at least one interacting unit that is adapted to move in a movement region that is larger than a process plane which contains the build plane. Methods for operating an apparatus for additively manufacturing three-dimensional objects may include moving at least one interacting unit of a robot device in a movement region that is larger than a process plane which contains the build plane.

### BRIEF DESCRIPTION

Aspects and advantages will be set forth in part in the following description, or may be obvious from the description, or may be learned through practicing the presently disclosed subject matter.

In one aspect, the present disclosure embraces apparatuses for additively manufacturing three-dimensional objects. Exemplary apparatuses may include at least one robot device that is adapted to move at least one interacting unit of the robot device in a movement region that is larger than a process plane which contains the build plane.

In another aspect, the present disclosure embraces robot devices for an apparatus for additively manufacturing three-dimensional objects. Exemplary robot devices may include at least one interacting unit that is adapted to move in a movement region that is larger than a process plane which contains the build plane.

In yet another aspect, the present disclosure embraces methods for operating an apparatus for additively manufacturing three-dimensional objects. Exemplary methods may include moving at least one interacting unit of a robot device in a movement region that is larger than a process plane which contains the build plane.

These and other features, aspects and advantages will become better understood with reference to the following description and appended claims. The accompanying drawings, which are incorporated in and constitute a part of this specification, illustrate exemplary embodiments and, together with the description, serve to explain certain principles of the presently disclosed subject matter.

### BRIEF DESCRIPTION OF THE DRAWINGS

A full and enabling disclosure, including the best mode thereof, directed to one of ordinary skill in the art, is set forth in the specification, which makes reference to the appended Figures, in which:

FIG. 1 shows an inventive apparatus according to a first embodiment in side view;

FIG. 2 shows a detail II of the apparatus according to a FIG. 1 in side view;

FIG. 3 shows an inventive apparatus according to a second embodiment in top view; and

FIG. 4 shows an inventive plant in top view.

Repeat use of reference characters in the present specification and drawings is intended to represent the same or analogous features or elements of the present disclosure.

### DETAILED DESCRIPTION

Reference now will be made in detail to exemplary embodiments of the presently disclosed subject matter, one or more examples of which are illustrated in the drawings. Each example is provided by way of explanation and should not be interpreted as limiting the present disclosure. In fact, it will be apparent to those skilled in the art that various modifications and variations can be made in the present disclosure without departing from the scope of the present disclosure. For instance, features illustrated or described as part of one embodiment can be used with another embodiment to yield a still further embodiment. Thus, it is intended that the present disclosure covers such modifications and variations as come within the scope of the appended claims and their equivalents.

As used herein, the terms “first”, “second”, and “third” may be used interchangeably to distinguish one component from another and are not intended to signify location or importance of the individual components. The terms “a” and “an” do not denote a limitation of quantity, but rather denote the presence of at least one of the referenced item.

Here and throughout the specification and claims, range limitations are combined and interchanged, and such ranges are identified and include all the sub-ranges contained therein unless context or language indicates otherwise. For example, all ranges disclosed herein are inclusive of the endpoints, and the endpoints are independently combinable with each other.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems.

Exemplary embodiments of the present disclosure will now be described in further detail.

The invention relates to an apparatus for additively manufacturing three-dimensional objects by means of successive layerwise selective consolidation of a build material in a build plane.

Apparatuses for additively manufacturing three-dimensional objects are generally known from prior art, e.g. apparatuses that are adapted to selectively consolidate build material and thereby, layerwise build a three-dimensional object. Typically, a process chamber is formed by a housing structure limiting the process chamber, e.g. via walls and a ceiling. For performing different tasks in the additive manufacturing process respective functional units are provided, e.g. an application unit adapted to apply build material in a build plane which can be consolidated to form the object. Respective functional units are usually carried via respective carrying structures, e.g. gantries, mechanical arms or the like and are therefore, mechanically coupled with the process chamber or the apparatus.

Thus, a movement region in which the described functional units can be moved is usually limited to the inside of the process chamber. Hence, the size of the process chamber limits the size of the build plane and therefore, the maximum size of an object that can be additively built with the apparatus, particularly within the process chamber of the apparatus. Further, the number and type of functional units provided inside the process chamber cannot be changed, at least during the same manufacturing process.

It is an object of the present invention to provide an improved apparatus for additively manufacturing three-dimensional objects, in particular an apparatus that is more versatile.

The object is inventively achieved by an apparatus according to claim 1. Advantageous embodiments of the invention are subject to the dependent claims.

The apparatus described herein is an apparatus for additively manufacturing three-dimensional objects, e.g. technical components, by means of successive selective layerwise consolidation of layers of a powdered build material (“build material”) which can be consolidated by means of an energy source, e.g. an energy beam, in particular a laser beam or an electron beam. A respective build material can be a metal, ceramic or polymer powder. A respective energy beam can be a laser beam or an electron beam. A respective apparatus can be an apparatus in which an application of build material and a consolidation of build material is performed separately, such as a selective laser sintering apparatus, a selective laser melting apparatus or a selective electron beam melting apparatus, for instance. Alternatively, the successive layerwise selective consolidation of build material may be performed via at least one binding material. The binding material may be applied with a corresponding application unit and, for example, irradiated with a suitable energy source, e.g. a UV light source.

The apparatus may comprise a number of functional units which are used during its operation. Exemplary functional units are an irradiation device which is adapted to selectively irradiate a build material layer disposed in the process chamber with at least one energy beam, and a stream generating device which is adapted to generate a gaseous fluid stream at least partly streaming onto or alongside a build plane with given streaming properties, e.g. a given streaming profile, streaming velocity, etc. The gaseous fluid stream is capable of being charged with non-consolidated particulate build material, particularly smoke or smoke residues generated during operation of the apparatus, while streaming onto or alongside the build plane. The gaseous fluid stream is typically inert, i.e. typically a stream of an inert gas, e.g. argon, nitrogen, carbon dioxide, etc.

According to the invention, the apparatus comprises at least one robot device which is adapted to move at least one interacting unit of the robot device in a movement region that is larger than a process plane which contains the build plane. Thus, the invention is based on the idea that instead of providing a functional unit, such as a coating device or an irradiation device which are coupled to a structure of the process chamber and thereby, limited to a movement region inside the process chamber, a robot device is provided that can move an interacting unit in a movement region which is larger than a process plane and therefore, is not limited by a process chamber. Compared to apparatuses for additively manufacturing three-dimensional objects known from prior art, the interacting unit can be moved more freely without limitations caused by process chamber walls.

In other words, the robot device may move the interacting unit in a moving region, e.g. across the process plane, particularly over an edge of the process plane and therefore, operations in the additive manufacturing process may be performed more efficiently. For example, a consolidation unit that is adapted to consolidate build material can be moved with defined, e.g. constant, velocity across the build plane, as the track segment along which the consolidation unit is accelerated and decelerated can be arranged outside the process plane, for example not over the build plane. The interacting unit can be accelerated and decelerated along a track segment before the interacting unit is arranged above the build plane allowing for a defined velocity via which the interacting unit can be moved across the build plane. Therefore, it is possible to avoid irregularities in the additive manufacturing process resulting from deviations in the movement pattern. In particular movement patterns can be prevented according to which the interacting unit can only be moved above the process plane and therefore, the movement region is limited to the interior of the process chamber, e.g. limited by the process plane and corresponding wall elements. Instead, the movement region is not limited to the size of the process plane and therefore, the movement patterns can be defined more freely.

Further, the size of the process plane, in particular the size of the build plane, can be adjusted or chosen independent from a size of a process chamber of the apparatus, as the robot device may move the interacting unit across an arbitrary sized build plane. Thus, it is possible to adjust the size of the build plane dependent on the size or the number of objects to be additively manufactured in the build plane.

According to an embodiment of the inventive apparatus, the robot device may be built as or may comprise at least one multi-axis-robot. Correspondingly, the robot device comprises at least one drive unit, e.g. motors, for driving robot segments of the multi-axis-robot, in particular to move or position the interacting unit. Via the multi-axis-robot it is possible to simultaneously move the interacting unit, e.g. about three or six axes or degrees of freedom, respectively. Particularly, it is possible to position the interacting unit in any arbitrary position and orientation with respect to the build plane in that the interacting unit can be used to perform the corresponding task in the additive manufacturing process, as required.

The robot device may be adapted to move the at least one interacting unit to a position over or move the at least one interacting unit across a freely standing build table. Thus, the process plane may be at least a part of a freely standing build table in that the process plane is not limited by walls. Therefore, the movement region in which the interacting unit can be moved via the robot device is not limited to the volume above the process plane, but the interacting unit can be moved freely across the freely standing build table or to any arbitrary position in the movement region. Thus, it is possible to use the robot device for a corresponding task in an additive manufacturing process that is performed in a build plane on the freely standing build table, wherein the size of the build table, and other geometrical parameters of the freely standing build table can be adjusted or chosen dependent on the additive manufacturing process, e.g. dependent on the size or the shape of the object to be additively manufactured. In particular, it is possible to use different build tables with different sizes of build planes for different additive manufacturing processes performed on the apparatus. In other words, the apparatus may be used on or may comprise different build tables or different build planes dependent on the individual process. For example, the build table may be exchanged dependent on the needed size of the build plane.

According to another embodiment, the robot device is structurally independent from the process plane. For example, the freely standing build table may be mechanically decoupled and separate from the robot device in that the robot device and the freely standing build table are not connected. Therefore, it is possible to move the freely standing build table or the robot device relative to each other, wherein the robot device may further move the interacting unit relative to the build table in order to position the interacting unit for performing the corresponding tasks in the additive manufacturing process. The apparatus may therefore, be regarded as portable or movable apparatus which can be moved relative to the build table on which an additive manufacturing process can be performed, as needed. The freely standing build table may, for example, be arranged in an inertized room, e.g. a vacuum chamber or a chamber filled with inert gas, wherein the build table stands freely inside the chamber and is not limited by a chamber wall, at least not limited on all edges.

As described before, the interacting unit may be adapted to perform at least one action relating to at least one process step of the additive manufacturing process. The interacting unit may therefore, be used to perform certain tasks in the additive manufacturing process that are usually performed by functional units structurally coupled with a process plane or a process chamber, for instance.

As described before, usually an application unit for applying build material in the build plane or an irradiation unit for irradiating build material are structurally coupled with the process chamber and therefore, the movement region of the application unit, for instance, is limited by the volume of the process chamber. By using the interacting unit that can be arbitrarily moved via the robot device, in particular independent from the process plane, limitations present in known additive manufacturing processes, do not occur, but the additive manufacturing apparatus can be used more versatile, as no process chamber limits the size and/or the shape of the object to be manufactured. Further, additional interacting units may be provided in the process, as needed. For example, additional robot devices can be deployed, if a demand information indicates that the work load of the apparatus or a specific task to be performed requires an additional interacting unit.

Inter alia, the at least one interacting unit may comprise an application unit adapted to apply build material in the build plane and/or a consolidation unit adapted to consolidate build material in a build plane and/or a carrying unit adapted to carry the additively built object and/or an unpacking unit adapted to unpack the object and/or a determination unit adapted to determine at least one parameter of the object, preferably a size of the object, and/or at least one parameter of the additive manufacturing process, preferably a temperature of at least one region of the build plane during the additive manufacturing process. In other words, the interacting unit itself may carry or comprise or be built as a functional unit which can perform one or more functions in the additive manufacturing process. It is also possible that the interacting unit is adapted to hold a build plate on which another interacting unit performs a corresponding task. Thus, it is possible that one interacting unit can hold or position a build plate in which one of the interacting unit applies build material or consolidates build material, for instance.

The at least one interacting unit may perform one or more tasks in the additive manufacturing process, e.g. an application task and/or a consolidation task, wherein combined interacting units adapted to perform a plurality of different tasks in the additive manufacturing process can be provided or alternatively, it is possible to provide specialized interacting units that are adapted to provide at least one specialized task in the additive manufacturing process. Of course, a combination of specialized interacting units and interacting units adapted to perform more than one task in the additive manufacturing process can be performed.

For example, an interacting unit may comprise an application unit for applying build material in the build plane which can be consolidated via a corresponding consolidation unit of the same interacting unit or of another interacting unit. After the additive manufacturing process is finished, the or another interacting unit can remove the non-consolidated build material via a corresponding unpacking unit and carry the additively built object via a carrying unit to a post-processing station, for instance.

The interacting unit may further function as determination unit which is adapted to determine at least one parameter of the object or the additive manufacturing process, e.g. an object parameter, such as a geometrical parameter of the object or a parameter of the additive manufacturing process, in particular a process parameter, such as an irradiation parameter, a parameter relating to the atmosphere near the build plane, for example a temperature and/or a gas parameter. Inter alia, the determination unit may comprise a sensor suitable for determining the corresponding parameter, for example a camera adapted to capture an image of the build plane.

The consolidation unit may, inter alia, comprise an irradiation unit which is adapted to emit an energy beam, e.g. emitted from an optical fiber or corresponding optical units, such as lenses or lens assemblies. It is also possible to otherwise consolidate the build material, e.g. by direct material deposition, binder jetting, filament deposition or the like. The interacting unit comprises respective means for consolidating the build material, as described before. In particular, the consolidation unit which is carried or comprised in the interacting unit is adapted to consolidate build material via at least one energy beam, in particular a laser beam or an electron beam or via at least one filament nozzle or via at least one inkjet or via direct material deposition. Of course, an arbitrary combination of different consolidation units can also be provided for example in different interacting units or in the same interacting unit. The interacting unit which comprises the consolidation unit can therefore, be moved via the robot device to an arbitrary position above the build plane and consolidate build material dependent on the object information, e.g. CAD data defining the three-dimensional shape of the object.

Further, the apparatus may comprise or can be coupled with at least one supply unit which is adapted to supply the at least one interacting unit with at least one resource, in particular process material and/or energy. Thus, the interacting unit which is carried via the robot device may be supplied by the supply unit with resources required in the additive manufacturing process. For example, the supply unit may provide the interacting unit with build material in that the interacting unit can apply the build material in the build plane. Further, the supply unit may supply a gas, such as an inert gas, e.g. argon, in that the interacting unit can generate a stream of gas inertizing the build material, e.g. before/while the build material is irradiated.

Particularly, the at least one supply unit is adapted to supply the at least one interacting unit with build material and/or gas and/or a consolidation means and/or energy, in particular adapted to recharge or replenish at least one storage unit of the at least one interacting unit. The robot device may comprise one or more storage units for the resources, such as a storage unit for build material and/or gas and/or energy. Thus, the supply unit may supply the resources needed by the interacting units for performing the corresponding task in the additive manufacturing process, e.g. the energy beam, binder material, build material, inert gas, or the like. The supply unit may be a separate unit or connected with the interacting unit, wherein the supply unit as a separate unit can be temporarily connected with the interacting unit or with the robot device to recharge the at least one storage unit with the corresponding resource. Further, it is also possible to use a supply unit to empty a specific storage unit in the interacting unit or the robot device. For example a storage unit for non-consolidated build material that is removed from the powder bed surrounding an additively built object can be emptied via the supply unit in that more non-consolidated build material can be removed and stored in the corresponding storage unit, e.g. in a post-processing step of the additive manufacturing process.

Additionally or alternatively, the at least one interacting unit may be connected to the supply unit via at least one connection means, in particular at least one fiber and/or cable and/or hose and/or pipe. The supply unit may comprise the connection means and supply the at least one resource for the additive manufacturing process via the connection means to the interacting unit. For example, the supply unit may supply an energy beam such as a laser beam through at least one optical fiber to the interacting unit. The energy beam may be emitted by the interacting unit and guided onto the build plane to consolidate the build material. Similarly, it is also possible to provide other resources to the interacting unit, such as build material, binder material, inert gas or the like, wherein cables, hoses or pipes are provided for guiding the resource to the interacting unit. Self-evidently, it is possible to supply some resources via connection means and supply other resources via storage units in the robot device.

The at least one robot device may comprise a communication unit adapted to send and/or receive interaction information to or from at least one other robot device and/or to or from at least one communication device. Thus, the apparatus may comprise two or more robot devices that may communicate with each other via communication units provided by the robot devices. In particular, one robot device may send and/or receive interaction information to or from at least one other robot device of the apparatus. Further, it is possible that a robot device of the apparatus receives interaction information from a robot device of another apparatus or that the robot device is adapted to send interaction information to a robot device of another apparatus. Besides, it is also possible that a central communication device is provided to which the at least one robot device of the apparatus can send interaction information and that interaction information can be sent by the communication device and can be received by the communication unit of the at least one robot device.

Inter alia, interaction information can be transmitted between the at least two robot devices and/or the at least one a communication device. This interaction information may comprise information relating to the status of the robot device or the status of the interacting unit of the robot device. For example, a demand for resources, such as build material, inert gas and the like can be communicated. Via the communication units or the communication device it is further possible to communicate to which part of the build plane the robot device and the interacting unit is assigned. The work load of the interacting unit or the specific task of the interacting unit can also be transmitted via the communication unit and/or the communication device.

The at least one robot device may further be adapted to receive build information relating to at least one area of the build plane to which the at least one interacting unit is at least temporarily assigned. For example, a demand for interaction via an interacting unit in at least one area of the build plane can be represented by the demand information, wherein dependent on the demand information, e.g. relating to the process steps required to complete an additive manufacturing process in an area of the build plane, one or more interacting units can be assigned to the area of the build plane.

In other words, if a complex structure has to be irradiated or consolidated in a respective area of the build plane, more interacting units can be assigned to the area and, if a comparatively simple structure has to be consolidated in another area, comparatively less interacting units can be assigned to that area. Therefore, the additive manufacturing process can be performed more efficiently. Self-evidently, each process step can involve the assignment of one or more interacting units, wherein the example above is not restricted to the consolidation process, but can be transferred to any arbitrary interaction in the additive manufacturing process, such as application of build material, removal of build material, generation of the gas stream and the like.

Besides, the invention relates to a plant for additively manufacturing three-dimensional objects, comprising at least two apparatuses for additively manufacturing three-dimensional objects by means of successive layerwise consolidation of a build material providing at least one build plane each, in particular at least two inventive apparatuses, as described before, wherein the plant comprises at least one robot device, in particular at least one robot device for each apparatus, which robot device comprises at least one interacting unit adapted to move in a movement region that is larger than a process plane which contains the build plane.

Thus, a plant may be provided that comprises two or more apparatuses for additively manufacturing three-dimensional objects, wherein the plant comprises at least one robot device that can be arbitrarily assigned to one of the apparatuses. For example, the robot device may be assigned temporarily to one apparatus for performing at least one process step in an additive manufacturing process, wherein after the process step is completed, the robot device may be assigned to another apparatus to perform an additive manufacturing process step or to the same apparatus for performing a further step in the additive manufacturing process.

The plant may particularly comprise at least two robot devices, wherein the plant is adapted to assign at least two interacting units of at least two different robot devices to the same apparatus dependent on the demand information, particularly relating to a work load of the at least one apparatus. As described before, the demand information may indicate the work load of the apparatus or the amount or complexity of process steps that need to be performed on the apparatus. Thus, if the work load of an apparatus indicates that more than one robot device or more than one interacting unit is needed, the plant may assign at least two robot devices with corresponding interacting units to the corresponding apparatus. The work load may, inter alia, be represented by a time required to perform a certain task in the additive manufacturing process, wherein that task can be subdivided to be performed by at least two or more interacting units in parallel.

Besides, the invention relates to a robot device for an apparatus for additively manufacturing three-dimensional objects by means of successive layerwise selective consolidation of a build material, in particular for an inventive apparatus, as described before, wherein the robot device comprises at least one interacting unit that is adapted to move in a movement region that is larger than a process plane which contains the build plane. Further, the invention relates to a method for operating an apparatus for additively manufacturing three-dimensional objects by means of successive layerwise consolidation of a build material, comprising the steps of moving at least one interacting unit of a robot device, in particular an inventive robot device, as described before, in a movement region that is larger than a process plane which contains the build plane.

Self-evidently, all details, features and advantages described with respect to the inventive apparatus, the inventive plant, the inventive robot device and the inventive method are fully transferable. In particular, the features, details and advantages may be arbitrarily exchanged and combined.

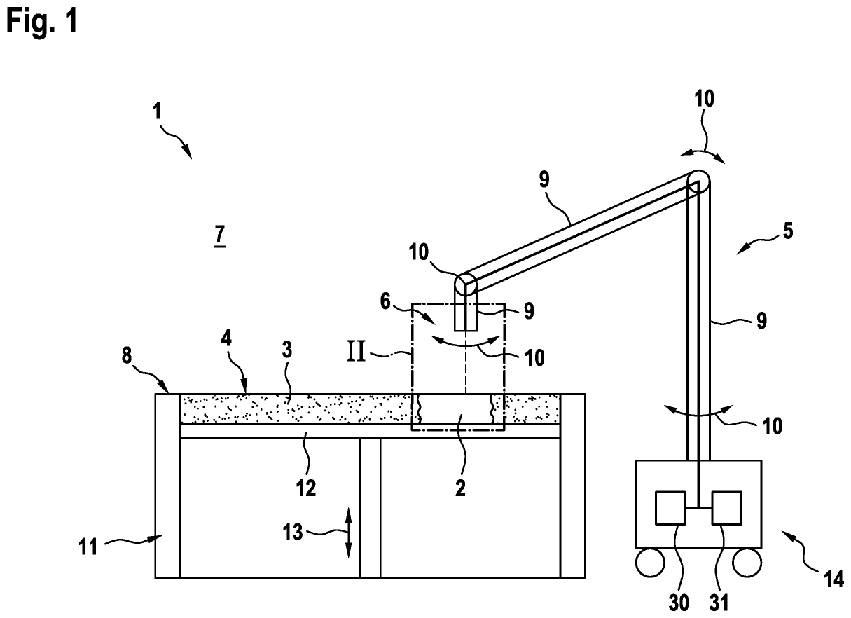

FIG. 1 shows an apparatus 1 for additively manufacturing three-dimensional objects 2 by means of successive layerwise selective consolidation of a build material 3 in a build plane 4. The apparatus 1 comprises a robot device 5 that is adapted to move an interacting unit 6 of the robot device 5 in a movement region 7 that is larger than a process plane 8 which contains the build plane 4.

The interacting unit 6 can be understood as “work head” or “interacting head” that can be moved across the build plane 4 or moved to any arbitrary position above the build plane 4. In this exemplary embodiment, the robot device 5 is built as multi-axis-robot that can move, e.g. turn and pivot, robot segments 9 as indicated via arrows 10 for moving or positioning the interacting unit 6. Of course, the depicted robot device 5 is merely exemplary and an arbitrary number of robot segments 9 and axes about which the robot segments 9 can be moved or pivoted can be arbitrarily chosen or changed, respectively.

In the depicted embodiment, the robot device 5 interacts with a freely standing build table 11. The term “freely standing” refers to a process plane 8 that is not limited via walls extending from edges of the process plane 8 as in a regular process chamber of an apparatus for additively manufacturing three-dimensional objects known from prior art. Instead, the build table 11 provides a build plate 12 on which the build material 3 may be applied and selectively consolidated to form the three-dimensional object 2. The build plate 12 in this exemplary embodiment is height-adjustable, as indicated via arrow 13. The build material 3 can be applied and properly consolidated, wherein the build plate 12 can be lowered to provide room for a subsequent layer of build material 3 to be applied on the previously consolidated structure. Alternatively, it is also possible to provide a freely standing build table 11 that only provides a build plate 12 that is fixed in position and not height-adjustable, wherein on the build plate 12, e.g. the upper surface of the build table 11, build material 3 can be applied and consolidated.

By providing the freely standing build table 11, it is possible to move the interacting unit 6 arbitrarily across the build plate 12, in particular across the edges of the process plane 8, wherein due to the freely standing build table 11, it is possible to accelerate and decelerate the interacting unit 6 in a region outside the build plane 4, e.g. not over the build plane 4, in that the movement of the interacting unit 6 above the build plane 4 or across the build plane 4, respectively, can be performed uniformly without negative interference by deceleration and acceleration movements.

As can further be derived from FIG. 1, the robot device 5 is structurally independent from the process plane 8, wherein the robot device 5 comprises a base unit 14 that is, for example, movable with respect to the build table 11 or can be mounted in a fixed position relative to the build table 11. For example, the base unit 14 can be moved to different positions around the build table 11 for reaching different sections of the build plane 4. It is also possible that the base unit 14 is mounted to a fixed position from which the robot device 5 can reach the entire build plane 4 or a defined part of the build plane 4 assigned to the robot device 5.

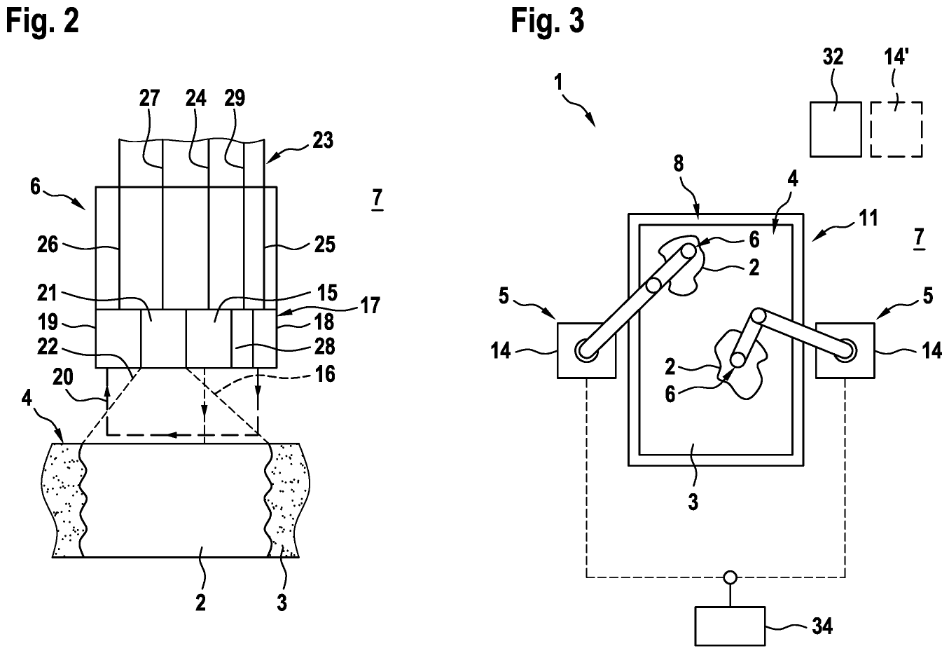

As can be derived from FIG. 2, showing the detail II from FIG. 1, the interacting unit 6 is positioned in a defined position in the movement region 7 above the build plane 4, in particular above an object 2 to be selectively irradiated from non-consolidated build material 3. The interacting unit 6 comprises different functional units, such as a consolidation unit 15, e.g. an optical unit for outputting an energy beam, in particular a laser beam 16, and guide the laser beam 16 to the build plane 4 to consolidate the build material 3. Further, the interacting unit 6 comprises a stream generating unit 17 with a stream intake 18 and a stream outlet 19 adapted to generate a gas stream 20 onto or alongside the build plane 4. The stream generating unit 17 can be used to inertize an area above the build plane 4 in which the build material 3 is consolidated. The stream generating unit 17 is, for example, adapted to blow or suck inert gas into the region above the build plane 4 and thereby, displace ambient air from the welding or consolidation region and simultaneously transport residues generated in the process away from the build plane 4.

The interacting unit 6 further comprises a determination unit 21 adapted to determine a parameter of the object 2 and/or of the additive manufacturing process performed on the apparatus 1. In this exemplary embodiment, the determination unit 21 is adapted to capture an image of the build plane 4 in a determination region 22, wherein it is possible to determine parameters of the energy beam 16 and the object 2. For example, the spot shape, the spot diameter, the intensity and the intensity distribution of the energy beam 16, as well as different geometrical parameters of the object 2, for example the shape of an actual layer of the object 2, can be determined. Further, the interacting unit 6 comprises an application unit 28 adapted to apply build material 3 in the build plane 4, e.g. deposit new layers of the build material 3 on the build plate 12 or on previously applied and partially consolidated layers of build material 3.

The different resources are supplied to the interacting unit 6 via connection means 23. For example, the laser beam 16 is supplied to the consolidation unit 15 via an optical fiber 24. The gas stream 20 is supplied to the stream generating unit 17, in particular to the gas intake 18 via a pipe 25 and removed from the gas outlet 19 via a pipe 26. The determination unit 21 is connected via a cable 27, for example to a control unit (not depicted). The application unit 28 is connected to a build material reservoir (not depicted) via a pipe or hose 29. Of course, the interacting unit 6 can comprise multiple other functional units, such as a build material removal unit via which build material 3 can be removed from the powder bed arranged in the build plane 4 for unpacking the object 2. A handling unit can further be provided (not depicted) which is adapted to handle the object 2, in particular lift the object 2 and move the object 2 from the build table 11 to another part of the apparatus 1 or a post-processing station, for instance.

The configuration of functional units depicted in FIG. 2 is merely exemplary, wherein other robot devices 5 may be provided with a different configuration or set of functional units. For example, it is also possible that each robot device 5 carries only one functional unit or that specific groups of functional units are formed and assigned to different interacting units 6. For example a determination group, a consolidation group, a stream generating group, a post-processing group and the like.

The robot device 5, as depicted in FIG. 1, can comprise multiple storage units 30, 31 for storing resources to be provided in the additive manufacturing process. For example, inert gas, build material 3, or other resources required for performing the additive manufacturing process can be stored in the storage units 30, 31. For example, one of the storage units 30, 31 can be built as or comprise an energy storage, such as a battery, for providing energy to move the robot device 5 or to generate the energy beam 16, for instance. The resources stored in the storage units 30, 31 can be provided via the connection means 23 to the different functional units, such as the consolidation unit 15 or the stream generating unit 17 or the application unit 28, for instance. Besides, it is also possible to provide the resources via an external supply unit, as will be described with respect to FIG. 3, 4. An arbitrary combination of external supply of resources and internal storage of resources is also possible.

FIG. 3 shows an apparatus 1 according to a second embodiment. In this exemplary second embodiment, the apparatus 1 comprises two robot devices 5 assigned to the same build plane 4. In other words, the robot devices 5 comprise interacting units 6 that can be moved via the robot devices 5 across the build plane 4 for performing actions related to the additive manufacturing process performed on the apparatus 1. For example, a specific area of the build plane 4 may be assigned to each of the robot devices 5 or the robot devices 5 may both be used on the entire build plane 4, as needed. Further, it is possible that the robot devices 5, in particular the base units 14 of the robot devices 5 are movable and can be moved to different positions relative to the build table 11.

Additionally, it is possible that the robot devices 5 may be temporarily coupled with a supply unit 32, as represented by the dashed contour 14′. In other words, it is possible to move the robot devices 5 to the supply unit 32 and temporarily couple the robot device 5 with the supply unit 32 in order to replenish or recharge storage units, such as the storage units 30, 31 depicted in FIG. 1. Inter alia, it is possible to recharge an energy storage, replenish a build material storage or inert gas storage or empty a storage for waste build material or the like.

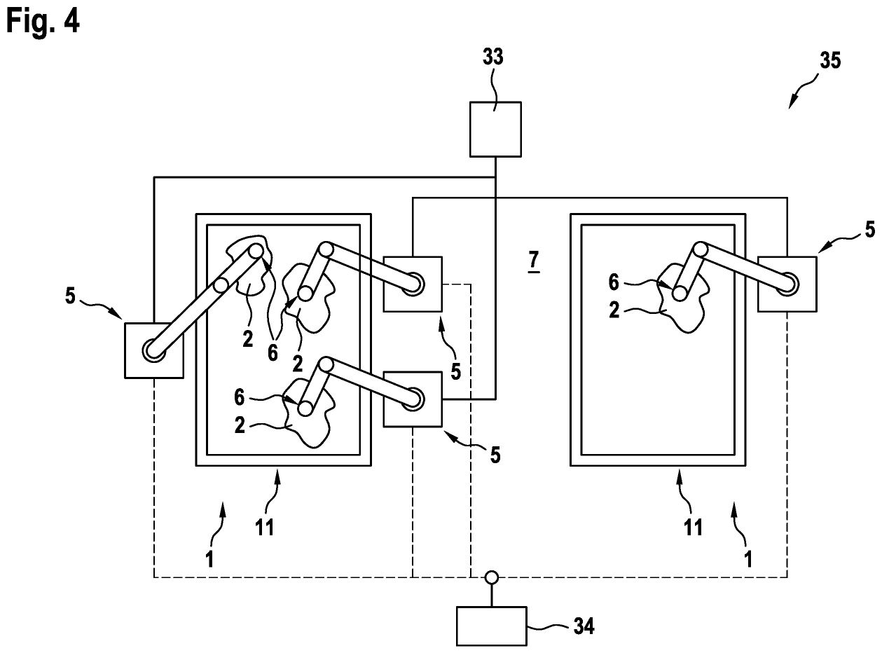

As described before, it is also possible to combine a supply unit 32 that can be temporarily coupled with the robot devices 5 for recharging storage units 30, 31 with the supply unit that is adapted to supply resources via connection means 23, e.g. from a separate supply unit, for example according to the supply unit 33 depicted in FIG. 4. FIG. 3 further shows that the apparatus 1 comprises a communication device 34 that is adapted to communicate with the robot devices 5, wherein the robot devices 5 each comprise a communication unit (not depicted). In other words, it is possible to send and receive interaction information from at least one other communication unit or from the (central) communication device 34.

Thus, the robot devices 5 can transmit information between each other or can send and receive information from the central communication device 34. Thus, control commands can, for example, may be sent from the communication device 34 to the robot devices 5. It is further possible that the robot devices 5 send corresponding status information about the status of the robot devices 5 to other robot devices 5 or to the communication device 34. For example, dependent on the corresponding control commands, it is possible to assign a robot device 5 to a specific area of a build plane 4. It is also possible to schedule when and where a robot device 5 is recharged, replenished or emptied, e.g. coupled with the supply unit 32.

FIG. 4 shows a plant 35 for additively manufacturing three-dimensional objects 2, wherein the plant 5 comprises four robot devices 5, e.g. robot devices 5, as depicted in the FIGS. 1-3. The plant 35 comprises two apparatuses 1, e.g. two freely standing build tables 11 and a plurality of robot devices 5, in this exemplary embodiment four robot devices 5. The robot devices 5 are permanently connected with a supply unit 33, e.g. via connection means 23, as described with respect to FIG. 2. As can be derived from FIG. 4, three robot devices 5 are assigned to a first build table 11 of one of the two apparatuses 1, whereas to the other build table 11 only one robot device 5 is assigned. The robot devices 5 may be assigned to different apparatuses 1 or different build tables 11 dependent on a demand information, which particularly relates to a work load of the corresponding apparatus 1. In this exemplary embodiment, for example, the work load of the first apparatus 1 is significantly higher than the work load of the second apparatus 1. Thus, three robot devices 5 are assigned to the first apparatus 1, whereas only one robot device 5 is assigned to the second apparatus 1.

Self-evidently, it is possible to change the assignment of the robot devices 5, as needed, for example dependent on a change in the work load. The work load may, inter alia, relate to the amount, the complexity or the duration of the actions to be performed in the additive manufacturing process performed on the respective apparatuses 1, e.g. in a defined process step or a couple of process steps. For example, dependent on the geometry of the object 2 be manufactured on the build planes 4, it is possible to decide how many structures have to be irradiated or how large the area is that is to be irradiated. Further, it is possible to take the amount of build material 3 to be removed into calculation or determine whether a determination process is necessary or the like.

Again, it is possible to send and receive interaction information via the communication units of the robot devices 5 and/or the communication device 34. For example, the communication device 34 may send corresponding control commands to the robot devices 5 to move the robot devices 5 and assign the robot devices 5 to the corresponding build planes 4. Further, it is possible that the robot devices 5 can be moved relative to the build tables 11 dependent on the control commands, for instance. It is also possible that the communication device 34 sends corresponding operational parameters to the robot devices 5, e.g. instructions on how to move the interacting units 6 to build the three-dimensional object 2 or perform other tasks in the additive manufacturing process.

Self-evidently, all details, features and advantages described with respect to the individual embodiments can be arbitrarily transferred, combined and exchanged. The inventive method may be performed on the apparatuses 1 and the plant 35.

Further aspects of the invention are provided by the subject matter of the following clauses:

1. An apparatus (1) for additively manufacturing three-dimensional objects (2) by means of successive layerwise selective consolidation of a build material (3) in a build plane (4), comprising: at least one robot device (5) that is adapted to move at least one interacting unit (6) of the robot device (5) in a movement region (7) that is larger than a process plane (8) which contains the build plane (4).

2. The apparatus of any preceding clause, wherein the robot device (5) is built as or comprises at least one multi axis robot.

3. The apparatus of any preceding clause, wherein the robot device (5) is adapted to move the at least one interacting unit (6) to a position over or move the at least one interacting unit (6) across a freely standing build table (11).

4. The apparatus of any preceding clause, wherein the at least one robot device (5) is structurally independent from the process plane (8).

5. The apparatus of any preceding clause, wherein the interacting unit (6) is adapted to perform at least one action relating to at least one process step of the additive manufacturing process.

6. The apparatus of any preceding clause, wherein the at least one interacting unit (6) comprises an application unit (28) adapted to apply build material (3) in a build plane (4) and/or a consolidation unit (15) adapted to consolidate build material (3) in a build plane (4) and/or a carrying unit adapted to carry the additively built object (2) and/or an unpacking unit adapted to unpack the object (2) and/or a determination unit (21) adapted to determine at least one parameter of the object (2), particularly a size of the object (2), and/or at least one parameter of the additive manufacturing process, particularly a temperature of at least one region of the build plane (4) during the additive manufacturing process.

7. The apparatus of any preceding clause, wherein the consolidation unit (15) of the at least one robot device (5) is adapted to consolidate build material (3) via at least one energy beam or via at least one filament nozzle or via at least one ink jet or via direct material deposition.

8. The apparatus of any preceding clause, comprising:

at least one supply unit (32, 33) adapted to supply the at least one interacting unit (6) with at least one resource, in particular process material and/or energy.

9. The apparatus of any preceding clause, wherein the at least one supply unit (32, 33) is adapted to provide the at least one interacting unit (6) with build material (3) and/or gas and/or a consolidation means and/or energy, in particular adapted to recharge at least one energy storage of the at least one interacting unit (6).

10. The apparatus of any preceding clause, wherein the at least one interacting unit (6) is connected to the supply unit (32, 33) via at least one connection means (28), in particular at least one fiber (24) and/or cable (27) and/or hose and/or pipe (25, 29).

11. The apparatus of any preceding clause, wherein the at least one robot device (5) comprises a communication unit adapted to send and/or receive interaction information to or from at least one other robot device (5) and/or to or from at least one communication device (34).

12. The apparatus of any preceding clause, wherein the at least one robot device (5) is adapted to receive build information relating to at least one area of the build plane (4) to which the at least one interacting unit (6) is at least temporarily assigned.

13. A plant (35) for additively manufacturing three-dimensional objects (2), comprising at least two apparatuses (1) for additively manufacturing of three-dimensional objects (2) by means of successive layerwise consolidation of a build material (3) providing at least one build plane (4) each, in particular at least two apparatuses (1) according to one of the preceding claims, wherein the plant (35) comprises at least one robot device (5), in particular at least one robot device (5) for each apparatus (1), which robot device (5) comprises at least one interacting unit (6) adapted to move in a movement region (7) that is larger than a process plane (8) which contains the build plane (4).

14. The plant of any preceding clause, wherein the plant (35) comprises the apparatus (1) of any preceding clause.

15. The plant of any preceding clause, wherein the plant (35) comprises at least two robot devices (5), wherein the plant (35) is adapted to assign at least two interacting units (6) of at least two different robot devices (5) to the same apparatus (1) dependent on a demand information, particularly relating to a work load of the at least one apparatus (1).

16. A robot device (5) for an apparatus (1) for additively manufacturing three-dimensional objects (2) by means of successive layerwise selective consolidation of a build material (3), in particular for an apparatus (1) of any preceding clause, wherein the robot device (5) comprises at least one interacting unit (6) that is adapted to move in a movement region (7) that is larger than a process plane (8) which contains the build plane (4).

17. The robot device (5) of any preceding clause, wherein the interacting unit (6) is adapted to perform at least one action relating to at least one process step of the additive manufacturing process.

18. The robot device (5) of any preceding clause, wherein the at least one interacting unit (6) comprises an application unit (28) adapted to apply build material (3) in a build plane (4) and/or a consolidation unit (15) adapted to consolidate build material (3) in a build plane (4) and/or a carrying unit adapted to carry the additively built object (2) and/or an unpacking unit adapted to unpack the object (2) and/or a determination unit (21) adapted to determine at least one parameter of the object (2), particularly a size of the object (2), and/or at least one parameter of the additive manufacturing process, particularly a temperature of at least one region of the build plane (4) during the additive manufacturing process.

19. The robot device (5) of any preceding clause, comprising: at least one supply unit (32, 33) adapted to supply the at least one interacting unit (6) with at least one resource, in particular process material and/or energy.

20. The robot device (5) of any preceding clause, wherein the at least one supply unit (32, 33) is adapted to provide the at least one interacting unit (6) with build material (3) and/or gas and/or a consolidation means and/or energy, in particular adapted to recharge at least one energy storage of the at least one interacting unit (6).

21. A method for operating an apparatus (1) for additively manufacturing three-dimensional objects (2) by means of successive layerwise consolidation of a build material (3), comprising: moving at least one interacting unit (6) of a robot device (5), in particular a robot device (5) according to claim 15, in a movement region (7) that is larger than a process plane (8) which contains the build plane (4).

22. The method of any preceding clause, wherein the method is performed using the apparatus (1) of any preceding clause.

23. The method of any preceding clause, wherein the method is performed using the robot device (5) of any preceding clause.

This written description uses exemplary embodiments to describe the presently disclosed subject matter, including the best mode, and also to enable any person skilled in the art to practice such subject matter, including making and using any devices or systems and performing any incorporated methods. The patentable scope of the presently disclosed subject matter is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. An apparatus for additively manufacturing three-dimensional objects by means of successive layerwise selective consolidation of a build material in a build plane, comprising:
at least one robot device that is adapted to move at least one interacting unit of the robot device in a movement region that is larger than a process plane which contains the build plane.

2. The apparatus of claim 1, wherein the robot device is built as or comprises at least one multi axis robot.

3. The apparatus of claim 1, wherein the robot device is adapted to move the at least one interacting unit to a position over or move the at least one interacting unit across a freely standing build table.

4. The apparatus of claim 1, wherein the at least one robot device is structurally independent from the process plane.

5. The apparatus of claim 1, wherein the interacting unit is adapted to perform at least one action relating to at least one process step of the additive manufacturing process.

6. The apparatus of claim 5, wherein the at least one interacting unit comprises an application unit adapted to apply build material in a build plane and/or a consolidation unit adapted to consolidate build material in a build plane and/or a carrying unit adapted to carry the additively built object and/or an unpacking unit adapted to unpack the object and/or a determination unit adapted to determine at least one parameter of the object, and/or at least one parameter of the additive manufacturing process.

7. The apparatus of claim 6, wherein the consolidation unit of the at least one robot device is adapted to consolidate build material via at least one energy beam or via at least one filament nozzle or via at least one ink jet or via direct material deposition.

8. The apparatus of claim 1, comprising:
at least one supply unit adapted to supply the at least one interacting unit with at least one resource.

9. The apparatus of claim 8, wherein the at least one supply unit is adapted to provide the at least one interacting unit with build material and/or gas and/or a consolidation means and/or energy.

10. The apparatus of claim 8, wherein the at least one interacting unit is connected to the supply unit via at least one connection means.

11. The apparatus of claim 1, wherein the at least one robot device comprises a communication unit adapted to send and/or receive interaction information to or from at least one other robot device and/or to or from at least one communication device.

12. The apparatus of claim 11, wherein the at least one robot device is adapted to receive build information relating to at least one area of the build plane to which the at least one interacting unit is at least temporarily assigned.

13. A plant for additively manufacturing three-dimensional objects, comprising at least two apparatuses for additively manufacturing of three-dimensional objects by means of successive layerwise consolidation of a build material providing at least one build plane each, wherein the plant comprises at least one robot device, which robot device comprises at least one interacting unit adapted to move in a movement region that is larger than a process plane which contains the build plane.

14. The plant of claim 13, wherein the plant comprises at least two robot devices, wherein the plant is adapted to assign at least two interacting units of at least two different robot devices to the same apparatus dependent on a demand information.

15. A robot device for an apparatus for additively manufacturing three-dimensional objects by means of successive layerwise selective consolidation of a build material, wherein the robot device comprises at least one interacting unit that is adapted to move in a movement region that is larger than a process plane which contains the build plane.

16. The robot device of claim 15, wherein the interacting unit is adapted to perform at least one action relating to at least one process step of the additive manufacturing process.

17. The robot device of claim 16, wherein the at least one interacting unit comprises an application unit adapted to apply build material in a build plane and/or a consolidation unit adapted to consolidate build material in a build plane and/or a carrying unit adapted to carry the additively built object and/or an unpacking unit adapted to unpack the object and/or a determination unit adapted to determine at least one parameter of the object, and/or at least one parameter of the additive manufacturing process.

18. The robot device of claim 15, comprising:
at least one supply unit adapted to supply the at least one interacting unit with at least one resource.

19. The robot device of claim 18, wherein the at least one supply unit is adapted to provide the at least one interacting unit with build material and/or gas and/or a consolidation means and/or energy.

20. The robot device of claim 15, wherein the at least one robot device comprises a communication unit adapted to send and/or receive interaction information to or from at least one other robot device and/or to or from at least one communication device, wherein the at least one robot device is adapted to receive build information relating to at least one area of the build plane to which the at least one interacting unit is at least temporarily assigned.
